(19) United States
(12) Patent Application Publication
(10) Pub. No.: US 2011/0171941 A1
(43) Pub. Date: Jul. 14, 2011

(54) SYSTEMS AND METHODS FOR GENERATING AUDIBLE REMINDERS ON MOBILE USER EQUIPMENT

(75) Inventors: RICHARD P. CUSICK, Los Angeles, CA (US); Pingle Sanjay Reddy, Sherman Oaks, CA (US)

(73) Assignee: United Video Properties Inc., Los Angeles, CA (US)

(21) Appl. No.: 13/072,167

(22) Filed: Mar. 25, 2011

Related U.S. Application Data
(63) Continuation of application No. 12/827,143, filed on Jun. 30, 2010.
Application No. 12/827,143 is a division of application No. 11/726,162, filed on Mar. 20, 2007, now abandoned.
Application No. 11/726,162 is a continuation-in-part of application No. 11/391,958, filed on Mar. 28, 2006.
(60) Provisional application No. 60/667,265, filed on Mar. 31, 2005.

(51) Int. Cl. H04N 5/445; H04M 3/42

(52) U.S. Cl. 455/414.1; 725/58

(57) ABSTRACT

A mobile user equipment may provide audible reminders for a user identified video. A user may set a triggering event for a video. Upon detecting the triggering event, an audible reminder for the video may be generated. The sound associated with the audible reminder may be such that, when heard by the user, it identifies the video to the user. The user may become aware of the broadcast of the video by hearing the audible reminder and without looking at the mobile device.

This application is a continuation-in-part of U.S. patent application Ser. No. 11/391,958, filed Mar. 28, 2006, which is a nonprovisional application of U.S. provisional patent Application No. 60/667,265, filed Mar. 31, 2005, each of which is hereby incorporated by reference herein in its entirety.

### BACKGROUND OF THE INVENTION

This application relates to interactive media guidance applications and more particularly to interactive media guidance applications implemented on mobile user equipment.

An interactive media guidance application implemented on mobile user equipment allows a user to access media information from any location where the mobile user equipment is in communication with a network.

Recent advances in mobile technology have resulted in the emergence of location-based services that can determine a user's location using technologies such as, for example, global positioning system (GPS), triangulation, or radio-frequency (RF) multipath fingerprinting. An example of a location-based service that is becoming more common in mobile phones is the ability to locate an individual who has dialed an emergency number (e.g., 9-1-1).

Media information, such as, for example television program listings may be region specific and the user may wish to obtain media information for the user's current location. It may be desirable to use location-based services to allow an interactive media guidance application to retrieve and display media information based on the user's current location.

### SUMMARY OF THE INVENTION

An interactive media guidance application may be implemented on mobile user equipment that is capable of performing location-based services. In some embodiments, the mobile user equipment may include a GPS sensor that communicates with one or more GPS satellites to pinpoint the user's current location. In some embodiments, the mobile user equipment may request that the network to which it is connected perform network-based techniques such as triangulation, RF multipath fingerprinting, or any other suitable technique to determine the user's current location.

In response to determining the user's current location, the interactive media guidance application may send a request to a media database to obtain media information for the user's current location. For the purposes of simplification and not limitation, the media database will be discussed herein primarily as a program listings database that provides program listings information, although any other suitable media database or combination of media databases may be used.

As part of the request, the interactive media guidance application may provide the program listings database with the user's current location in any suitable format that is accepted by the program listings database (e.g., ZIP code, city and state, area code, etc.). The program listings database may respond by transmitting program listings information for the specified location to the interactive media guidance application, which may then be displayed by the interactive media guidance application.

The interactive media guidance application may continue to update the program listings information at periodic intervals. Alternatively, the user may manually initiate an update of program listings information.

In some embodiments a user interface is presented to allow a user to set an audible reminder for a video. The audible reminder may, at a predetermined time, generate a sound on a mobile device that when heard by the user, identifies the video to the user. The sound may be for example the theme song of the identified video.

In one embodiment, the audible reminder may be set at a remote device for a video. The remote device may retrieve an audio signal that identifies the video to the user from a database of audio signals. This audio signal may be transmitted to the mobile device, at a predetermined time, in the form of an MMS message. The predetermined time may be the broadcast time of the video or a short period of time before the broadcast time of the video. When the mobile device detects the receipt of the MMS message, it may generate a sound, that when heard by the user identifies the video to the user, through its speaker.

In another embodiment, the audible reminder may be set at a mobile device for a video. At a predetermined time, the mobile device may retrieve an audio signal that identifies the video to the user from a locally stored database of audio signals. The mobile device may then generate a sound through its speaker that, when heard by the user, identifies the video to the user.

In another embodiment, the audible reminder may be set at a remote device or a mobile device for a video. The mobile device may request the audio signal from the remote device for the identified video. The remote device may retrieve the audio signal from a database of audio signals and transmit the retrieved signal to the mobile device. The mobile device may store the retrieved signal in a local memory. The local memory may store audio signals only for videos for which the user set an audible reminder. At the predetermined time, the mobile device may retrieve the audio signal from the local memory and generate a sound that, when heard by the user, identifies the video to the user.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative interactive media guidance system in accordance with the present invention.

FIG. 2 is a diagram of illustrative mobile user equipment in accordance with the present invention.

FIG. 3a shows an illustrative screen of an interactive media guidance application implemented on mobile user equipment for providing a user with a menu in accordance with one embodiment of the present invention.

FIG. 3b shows an illustrative screen of an interactive media guidance application implemented on mobile user equipment for selecting settings in accordance with one embodiment of the present invention.

FIG. 3c shows an illustrative screen for displaying program listings information in an interactive media guidance application implemented on mobile user equipment in accordance with one embodiment of the present invention.

FIGS. 3d-f show an illustrative screen of an interactive media guidance application implemented on mobile user equipment for displaying the status of program listings information updates in accordance with one embodiment of the present invention.

FIG. 3g shows an illustrative screen of an interactive media guidance application implemented on mobile user equipment for displaying updated program listings information in accordance with one embodiment of the present invention.

FIG. 4 is an illustrative flow diagram for generating an audible reminder on mobile user equipment in accordance with an embodiment of the present invention.

FIG. 5 is an exemplary display of a program listing on a mobile device in accordance with an embodiment of the present invention.

FIG. 6 is an exemplary display screen on a mobile device for setting an audible reminder in accordance with an embodiment of the present invention.

FIG. 7 is an illustrative flow diagram for generating an audible reminder on mobile user equipment in accordance with an embodiment of the present invention.

FIG. 8 is a block diagram illustration of a mobile device system for generating audible reminders in accordance with an embodiment of the present invention.

FIG. 9 is an illustrative flow diagram for setting an audible reminder at a remote device and generating the reminder on mobile user equipment in accordance with an embodiment of the present invention.

FIG. 10 is an exemplary display screen on a remote device for setting an audible reminder in accordance with an embodiment of the present invention.

FIG. 11 is a block diagram illustration of a remote device and a mobile device system for generating audible reminders in accordance with an embodiment of the present invention.

FIG. 12 is an exemplary subset of entries in a database of audio signals in accordance with an embodiment of the present invention.

FIG. 13 is an illustrative flow diagram 1300 for setting an audible reminder at a remote device and generating the reminder on mobile user equipment 108 in accordance with another embodiment of the present invention.

FIG. 14 is an illustrative flow diagram for generating an audible reminder in accordance with another embodiment of the present invention.

FIG. 15 is an exemplary display screen on a mobile device of an audible reminder MMS message in accordance with an embodiment of the present invention.

FIG. 16a is an illustrative flow diagram for using an interactive media guidance application implemented on mobile user equipment to retrieve program listings information based on a user's current location in accordance with one embodiment of the present invention.

FIG. 16b is an illustrative flow diagram for determining the user's current location using a GPS sensor implemented on mobile user equipment in accordance with one embodiment of the present invention.

FIG. 16c is an illustrative flow diagram for determining the user's current location using a network-based positioning technique in accordance with one embodiment of the present invention.

FIG. 16d is an illustrative flow diagram for using an interactive media guidance application implemented on mobile user equipment to retrieve program listings information based on a user's current location in accordance with one embodiment of the present invention.

FIG. 16e is an illustrative flow diagram for using an interactive media guidance application implemented on mobile user equipment to update program reminders based on a user's location in accordance with one embodiment of the present invention.

FIG. 16f is an illustrative flow diagram for using an interactive media guidance application implemented on mobile user equipment to update favorite channels based on a user's location in accordance with one embodiment of the present invention.

### DETAILED DESCRIPTION OF THE PREFERRED EMBODIMENTS

The amount of media available to users in any given media delivery system can be substantial. Consequently, many users desire a form of media guidance, an interface that allows users to efficiently navigate media selections and easily identify media that they may desire. An application that provides such guidance is referred to herein as an interactive media guidance application or, sometimes, a guidance application.

Interactive media guidance applications may take various forms depending on the media for which they provide guidance. One typical type of media guidance application is an interactive television program guide. Interactive television program guides are well-known guidance applications that, among other things, allow users to navigate among and locate television programming viewing choices and, in some systems, digital music choices. The television programming (and music programming) may be provided via traditional broadcast, cable, satellite, Internet, or any other means. The programming may be provided on a subscription basis (sometimes referred to as premium programming), as pay-per-view programs, or on-demand such as in video-on-demand (VOD) systems.

With the advent of the Internet, mobile computing, and high-speed wireless networks, users are able to access media on personal computers (PCs) and devices on which they traditionally could not. Non-television-centric platforms (i.e., platforms that distribute media with equipment not part of the user's broadcast, cable or satellite television-delivery network) allow users to navigate among and locate desirable video clips, full motion videos (which may include television programs), images, music files, and other suitable media. Consequently, media guidance is also necessary on modern non-television-centric platforms. For example, media guidance applications may be provided as online applications (i.e., provided on a web-site), or as stand-alone applications or clients on user equipment devices, such as, for example, hand-held computers, personal digital assistants (PDAs), cellular telephones, or traditionally-passive devices that have been enhanced with circuitry for operating interactive media guidance applications (e.g., wrist watches, telephone hand sets, appliances, etc.). In some systems, users may control equipment remotely via a media guidance application. For example, users may access an online media guide and set recordings or other settings on their in home equipment. This may be accomplished by the online guide controlling the user's equipment directly or via another media guide that runs on the user's equipment. Remote access of interactive media guidance applications is discussed in greater detail in Ellis et al. U.S. Patent Publication No. 2005/0028208-A1, which is hereby incorporated by reference herein in its entirety.

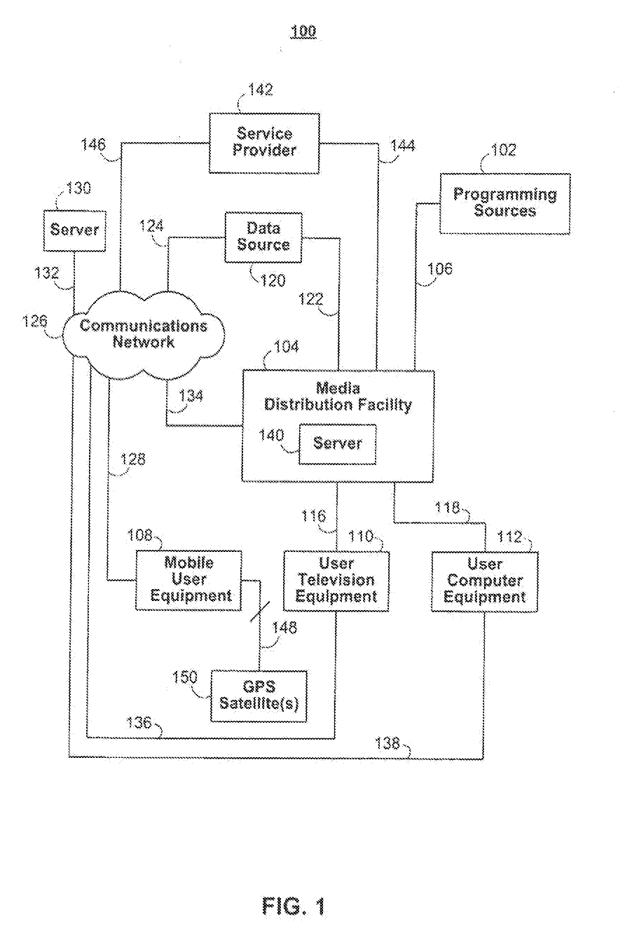

An illustrative interactive media guidance system 100 in accordance with the present invention is shown in FIG. 1. System 100 is intended to illustrate a number of approaches by which media of various types, and guidance for such media, may be provided to (and accessed by) end-users. The present invention, however, may be applied in systems employing any one or a subset of these approaches, or in systems employing other approaches for delivering media and providing media guidance.

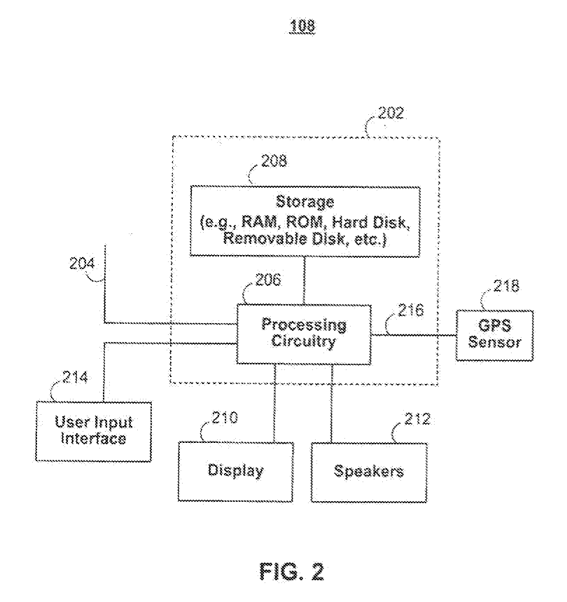

System 100 may include any one or more of mobile user equipment 108, user television equipment 110, and user computer equipment 112. Mobile user equipment 108 may be any suitable mobile device including, for example, a cellular phone, a personal digital assistant (PDA), a laptop computer, a handheld computer, a mobile media player, a wireless e-mail device, and a vehicle-based media system. In some embodiments, mobile user equipment 108 may include a GPS sensor that communicates with a plurality of GPS satellites 150 to determine the location of mobile user equipment 108. An illustrative embodiment of mobile user equipment 108 is discussed below in greater detail in connection with FIG. 2.

User television equipment 110 may include, for example, a television and any one or more of a set-top box and a recording device. User computer equipment 112 may be any suitable computing device including for example, a desktop computer, laptop computer, and handheld computer. Illustrative embodiments of user television equipment 110 and user computer equipment 112 (FIG. 1) are discussed in greater detail in Thomas et al. U.S. Patent Application Publication No. 2005/0120373 A1, which is hereby incorporated by reference herein in its entirety.

The first approach represents a typical television-centric system in which users may access media (e.g., television programming and/or digital audio). This includes programming sources 102 and distribution facility 104. Media is provided from programming sources 102 to distribution facility 104, using communications path 106. Communications path 106 may be a satellite path, a fiber-optic path, a cable path, or any other suitable wired or wireless communications path or combination of such paths.

Programming sources 102 may be any suitable sources of television and music programming, such as television broadcasters (e.g., NBC, ABC, and HBO) or other television or music production studios. Programming sources 102 may provide television programming in a variety of formats in high definition and standard definition, such as, for example, 1080p, 1080i, 720p, 480p, 480i, and any other suitable format. There are typically numerous programming sources 102 in system 100, but only one is shown in FIG. 1 to avoid overcomplicating the drawing.

Distribution facility 104 may be a cable system headend, a satellite distribution facility, a television broadcaster, or any other suitable facility for distributing video media (e.g., television programs, video-on-demand programs, pay-per-view programs) and audio media (e.g., music programming and music clips) to the equipment of subscribers of the corresponding cable, satellite, or Internet protocol television (IPTV) system. In some approaches, distribution facility 104 may also distribute other media to users, such as video and audio clips, web pages, and interactive applications, that may be offered to subscribers of a given cable, satellite, or IPTV system. There are typically numerous distribution facilities 104 in system 100, but only one is shown in FIG. 1 to avoid overcomplicating the drawing.

Distribution facility 104 may be connected to user television equipment 110 and user computer equipment 112.

User equipment devices 110 and 112 may receive media (such as television programs, music, web pages, etc.) and other data from distribution facility 104 over communications paths, such as communications paths 116 and 118, respectively. User equipment devices 110 and 112 may also transmit signals to distribution facility 104 over paths 116 and 118, respectively. Paths 116 and 118 may be cables or other wired connections, free-space connections (e.g., for broadcast or other wireless signals), satellite links, or any other suitable link or combination of links.

A second approach illustrated in FIG. 1 by which media and media guidance are provided to end users is a non-television-centric approach. In this approach, media such as video (which may include television programming), audio, images, web pages, or any suitable combination thereof, are provided to mobile user equipment 108, user television equipment 110, and user computer equipment 112 by server 130 via communications network 126. This approach is non-television-centric because media (e.g., television programming) is provided by and delivered at least partially, and sometimes exclusively, via equipment that have not traditionally been primarily focused on the television viewing experience. Non-television-centric equipment is playing a larger role in the television viewing experience.

In some embodiments for this approach, communications network 126 is the Internet. Server 130 may provide for example, a website that is accessible to the user's equipment and provides an online guidance application for the user. In such approaches, the user's equipment may be, for example, a PC or a hand-held device such as a PDA or web-enabled cellular telephone that incorporates a web browser. In other embodiments, server 130 uses the Internet as a transmission medium but does not use the Web. In such approaches, the user's equipment may run a client application that enables the user to access media. In still other approaches, communications network 126 is a private communications network, such as a cellular phone network, that does not include the Internet.

In yet other approaches, communications network 126 includes a private communications network and the Internet. For example, a cellular telephone or other mobile-device service provider may provide Internet access to its subscribers via a private communications network, or may provide media such as video clips or television programs to its subscribers via the Internet and its own network.

The aforementioned approaches for providing media may, in some embodiments, be combined. For example, a distribution facility 104 may provide a television-centric media delivery system, while also providing users' equipment (e.g., 110 and 112) with access to other non-television-centric delivery systems provided by server 130. For example, a user's equipment may include a web-enabled set-top box or a television enabled PC. Distribution facility 104 may, in addition to television and music programming, provide the user with Internet access whereby the user may access server 130 via communications network 126. Distribution facility 104 may communicate with communications network 126 over any suitable path 134, such as a wired path, a cable path, fiber-optic path, satellite path, or combination of such paths.

Media guidance applications may be provided using any approach suitable for the type of media and distribution system for which the applications are used. Media guidance applications may be, for example, stand-alone applications implemented on users' equipment. In other embodiments, media guidance applications may be client-server applications where only the client resides on the users' equipment. In still other embodiments, guidance applications may be provided as web sites accessed by a browser implemented on the users' equipment. Whatever the chosen implementation, the guidance application requires information about the media for which it is providing guidance. For example, titles or names of media, brief descriptions, or other information may be necessary to allow users to navigate among and find desired media selections.

In some television-centric embodiments, for example, the guidance application may be a stand-alone interactive television program guide that receives program guide data via a data feed (e.g., a continuous feed, trickle feed, or data in the vertical blanking interval of a channel). Data source 120 in system 100 may include a program listings database that is used to provide the user with associated program data such as schedule information, program descriptions, program information (e.g., actors, directors, release date, ratings, genre, etc.), related articles, interviews, reviews, metadata having links to related content, descriptive metadata, and other similar content or data relating to the television programs. In some embodiments, the data may also include content or video related to television programs. Data source 120 may also be used to provide promotions and advertisements (e.g., program guide advertisements and promotions for television programs), real-time data such as sports scores, stock quotes, news data, and weather data, application data for one or more media guidance applications or other interactive applications, and any other suitable data for use by system 100. As another example, data source 120 may provide data indicating the types of information that may be included in interactive media guidance overlays (e.g., at the request of the user, absent user modification, etc.).

Program guide data may be provided to user equipment using any suitable approach. For example, program schedule data and other data may be provided to the user equipment on a television channel sideband, in the vertical blanking interval of a television channel, using an in-band digital signal, using an out-of-band digital signal, or by any other suitable data transmission technique. Program schedule data and other data may be provided to user equipment on multiple analog or digital television channels. Program schedule data and other data may be provided to the user equipment with any suitable frequency (e.g., continuously, daily, in response to a request from user equipment, etc.).

In some television-centric embodiments, guidance data from data source 120 may be provided to users' equipment using a client-server approach. For example, a guidance application client residing on the user's equipment may initiate sessions with server 140 to obtain guidance data when needed.

There may be multiple data sources (such as data source 120) in system 100, although only one data source is shown in FIG. 1 to avoid overcomplicating the drawing. For example, a separate data source may be associated with each of a plurality of television broadcasters and may provide data that is specific to those broadcasters (e.g., advertisements for future programming of the broadcasters, logo data for displaying broadcasters, logos in program guide display screens, etc.). Data source 120 and any other system components of FIG. 1 may be provided using equipment at one or more locations. Systems components are drawn as single boxes in FIG. 1 to avoid overcomplicating the drawings.

Data source 120 may provide data to distribution facility 104 over communications path 122 for distribution to the associated user equipment over paths 116 and 118 (e.g., when data source 120 is located at a main facility). Communications path 122 may be any suitable communications path such as a satellite communications path or other wireless path, a fiber-optic or other wired communications path, a path that supports Internet communications, or other suitable path or combination of such paths.

Data source 120 may also provide guidance data directly to mobile user equipment 108 (over path 124, communications network 126, and path 128), user television equipment 110 (over path 124, communications network 126, and path 136), and user computer equipment 112 (over path 124, communications network 126, and path 138). Paths 124, 128, 136, and 138 may be wired paths such as telephone lines, cable paths, fiber-optic paths, satellite paths, wireless paths, and any other suitable paths or a combination of such paths. Communications network 126 may be any suitable communications network, such as the Internet, the public switched telephone network, or a packet-based network.

Mobile user equipment 108, user television equipment 110, and user computer equipment 112 may use the program schedule data and other interactive media guidance application data to display program listings and other information (e.g., information on digital music) for the user. An interactive television program guide application or other suitable interactive media guidance application may be used to display the information on the user's display (e.g., in one or more overlays that are displayed on top of video for a given television channel). Interactive displays may be generated and displayed for the user using any suitable approach. In one suitable approach, distribution facility 104, server 130, or another facility, may generate application display screens and may transmit the display screens to user equipment for display. In another suitable approach, user equipment may store data for use in one or more interactive displays (e.g., program schedule data, advertisements, logos, etc.), and an interactive media guidance application implemented at least partially on the user equipment may generate the interactive displays based on instructions received from distribution facility 104, server 130 or another facility. In some embodiments of the present invention, user equipment may store only the data that is used to generate the interactive television displays (e.g., storing logo data for a particular television broadcaster only if the logo is to be included in one or more interactive television displays). In some embodiments of the present invention, user equipment may store data that is not necessarily used to generate the interactive television displays (e.g., storing advertisements associated with a particular television broadcaster that may or may not be displayed depending on, for example, the outcome of negotiations with the television broadcaster). Any other suitable approach or combination of approaches may be used to generate and display interactive overlays for the user.

In still other embodiments, interactive media guidance applications (television-centric and non-television centric) may be provided online as, for example, websites. For example, server 130 may provide an online interactive television program guide. AS another example, user computer equipment 112 may be web-enabled to allow the user to access an online guidance application (which may be modified from its original version to make it appropriate for user computer equipment 112). Alternatively, user computer equipment 112 may have an applet that communicates with server 130 to obtain guidance data via the Internet.

Server 130 may receive program schedule data and other data from data source 120 via communications path 124, communications network 126, communications path 132, or another suitable path or combination of paths. Path 132 may be a satellite path, fiber-optic path, wired path, or any other path or combination of paths. Mobile user equipment 108 may access the online interactive media guidance application and other sources from server 130 via communications path 128. Mobile user equipment 108 may also access the application and other services on server 130 via communications path 114, distribution facility 104, and communications path 134.

User equipment such as user television equipment 110 and user computer equipment 112 may access the online interactive media guidance application and server 130 using similar arrangements. User television equipment 110 may access the online interactive media guidance application and server 130 using communications path 136 or using path 116, distribution facility 104, and path 134. User computer equipment 112 may access the online interactive media guidance application and server 130 using communications path 138 or using path 118, distribution facility 104, and path 134. Paths 136 and 138 may be any suitable paths such as wired paths, cable paths, fiber-optic paths, wireless paths, satellite paths, or a combination of such paths.

If desired, an interactive media guidance application such as a network-based video recorder or a video-on-demand application may be supported using server 140, server 130, or equipment at service provider 142. Video-on-demand content and video recorded using a network-based video recorder arrangement may be stored on server 140, server 130, or at service provider 142 and may be provided to the user equipment when requested by users. An interactive television program guide, for example, may be used to support the functions of a personal video recorder (sometimes called a digital video recorder) that is implemented using user television equipment 110 or user computer equipment 112. Illustrative equipment that may be used to support personal video recorder functions include specialized personal video recorder devices, integrated receiver decoders (IRDs), set-top boxes with integrated or external hard drives, or personal computers with video recording capabilities.

FIG. 2 shows an illustrative embodiment of mobile user equipment 108 in accordance with the present invention. Mobile user equipment 108 may include control circuitry 202, input/output 204, display 210, speakers 212, user input interface 214, and GPS sensor 218.

Control circuitry 202 may include processing circuitry 206 and storage 208. Processing circuitry 206 may be any suitable processor such as, for example, a microprocessor, a microcontroller, a digital signal processor, or a programmable logic device. Storage 208 may be any suitable storage device or combination of suitable storage devices including, for example, a magnetic storage device, solid state memory, or an optical disk drive. Storage 208 may be controlled by processing circuitry 206 to store or retrieve data.

Input/output 204 may include a wireless transceiver that allows mobile user equipment 108 to communicate wirelessly with communications network 126 (FIG. 1). Input/output 204 may be used to transmit requests to network processors (e.g., server 130 or 140) and receive information from media databases (e.g., server 130 or 140).

A user may control control circuitry 202 using user input interface 214. User input interface 214 may be any suitable user interface, such as a mouse, trackball, keypad, keyboard, touch screen, touch pad, voice recognition interface, or a remote control.

Display 210 may be any suitable display device such as, for example, an LCD display. Speakers 212 may be any suitable audio speaker. Display 210 and speakers 212 may be controlled by processing circuitry 206.

An interactive media guidance application may be implemented on mobile user equipment 108. Processing circuitry 206 may execute the interactive media guidance application and direct display 210 to display screens of the interactive media guidance application. The screens of the interactive media guidance application may include menus and options. The user may interact with the menus and options using user input interface 214.

The interactive media guidance application may allow the user to remotely perform program guide functions. In particular, the interactive media guidance application may allow the user to access media information (e.g., program listings information) on mobile user equipment 108. Processor 206 may send a request for media information to a media database (e.g., server 130 or server 140 (FIG. 1)) via input/output 204 and display the received media information on, for example, a media listings screen.

The interactive media guidance application may allow the user to search for media information using various criteria (e.g., title, date, or network). In some embodiments, the interactive media guidance application may search media information stored on storage 208. In some embodiments, the interactive media guidance application may send a search request to a media database (e.g., server 130 or server 140 (FIG. 1)) via input/output 204 and communications network 126. The interactive media guidance application may display a list of media that meet the search criteria.

The interactive, media guidance application may also allow the user to set a reminder for a television program. The reminder may be displayed by mobile user equipment 108 to alert the user that the television program is about to begin. In some embodiments, the interactive media guidance application may allow the user to send reminders to another mobile user equipment via input/output 204 and communications network 126. The reminder may be displayed by the other, mobile user equipment prior to the beginning of the television program.

The interactive media guidance application may also allow the user to set an audible reminder for a video (e.g., television program, video-on-demand program, pay-per-view program, music video, or any other program for which the user desires to set a reminder). The audible reminder may be set using mobile user equipment 108, or any other remote device with or without access to a web server such as user television equipment 110, user computer equipment 112, personal digital assistant (PDA), laptop computer, or any other device with local or portable access to the internet.

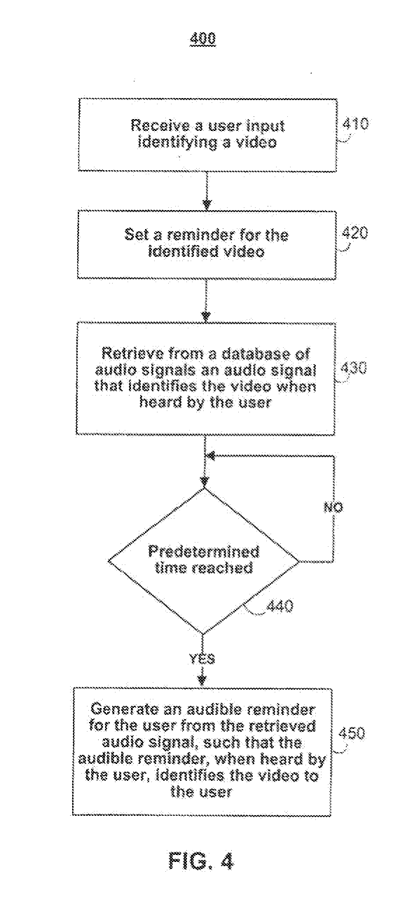

The audible reminder may cause an audio signal to be generated by mobile user equipment 108 when the video is about to begin. The sound produced by the audio signal may identify the video to the user such there is no need for the user to view the reminder on the display. For example, the audio signal identifies the video such that when the user hears the audio signal, the user knows precisely what video is about to begin and is not just be alerted that any show is coming on. The audio signal may identify and may be unique to for example, a specific show or program, a particular episode of a series of programs, or all programs of a particular series of programs. For example, the “Seinfeld” theme song may be the audio signal that, when heard by the user, identifies to the user that one or more episodes of the “Seinfeld” series of programs is about to begin. Audible reminders are described below in more detail in connection with FIGS. 4-15.

The interactive media guidance application may allow the user to remotely schedule recordings of television programs on recording devices. In some embodiments, mobile user equipment 108 may be associated with user equipment (e.g., user television equipment 110 or user computer equipment 112 (FIG. 1)) having recording capabilities. In some embodiments, the interactive media guidance application may prompt the user to select user equipment with which to record television programs. Processing circuitry 206 may send a command to record a television program to an interactive media guidance application implemented on the user equipment via input/output 204, communications network 126, and media distribution facility 104. Remote recording is discussed in greater detail in Ellis et al. U.S. Patent Publication No. 2005/0028208-A1, which has been incorporated by reference in its entirety.

The interactive media guidance application implemented on mobile user equipment 108 may also be configured to perform location-based services. The location of mobile user equipment 108 may be determined using several different approaches. In one approach, GPS sensor 218 may receive timing signals from a plurality of GPS satellites 150 (FIG. 1). GPS sensor 218 may analyze the received timing signals to determine the distance to each of GPS satellites 150. GPS sensor 218 may calculate the location of mobile user equipment 108 based on the distances to GPS satellites 150.

In another approach, a network processor (e.g., server 130 or server 140 (FIG. 1)) may triangulate the radio emissions from mobile user equipment 108 to determine the location of mobile user equipment 108.

In yet another approach, the network processor may perform RF multipath fingerprinting by creating a database of fingerprints that correspond to radio emissions transmitted from different locations. The network processor may determine the location of mobile user equipment 108 by matching the received radio emissions to one of the stored fingerprints.

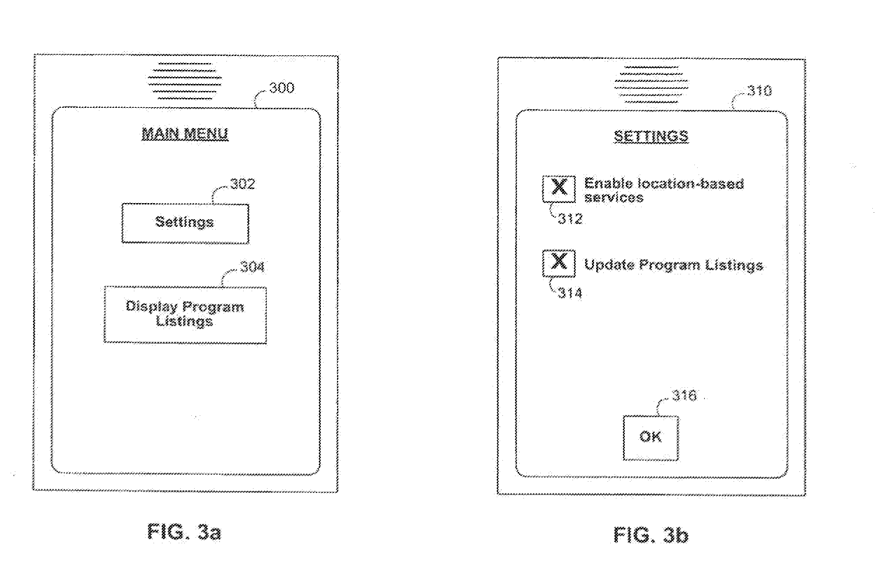

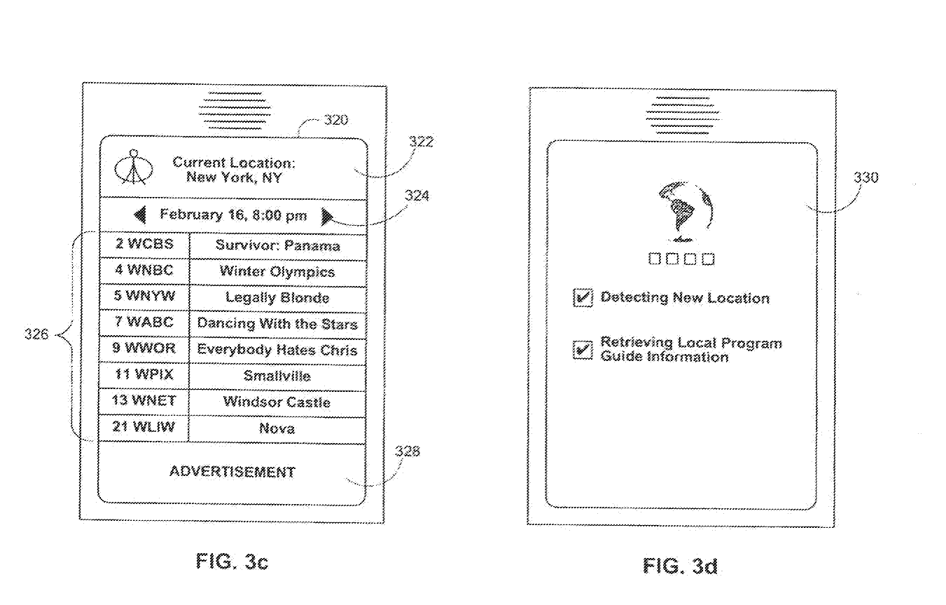

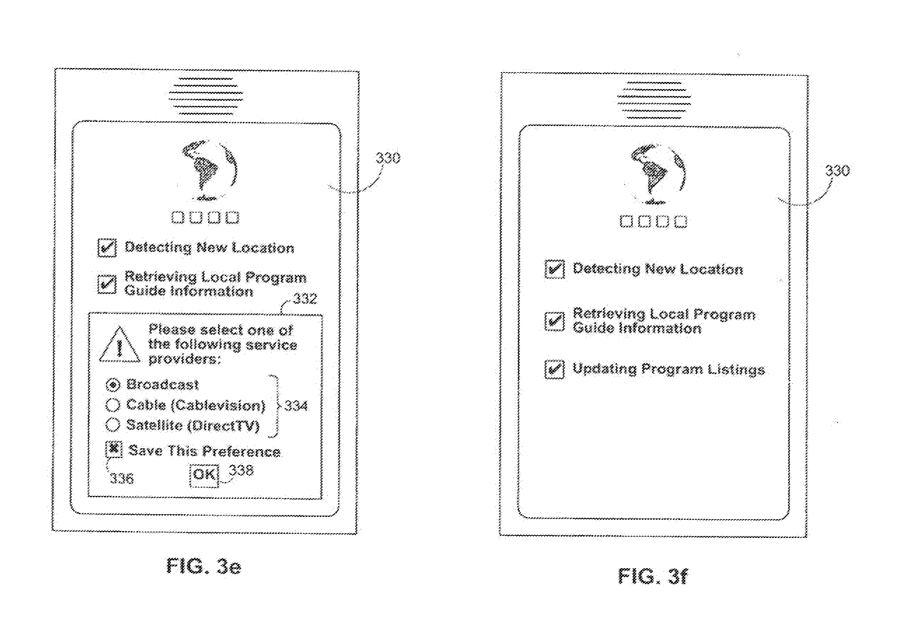

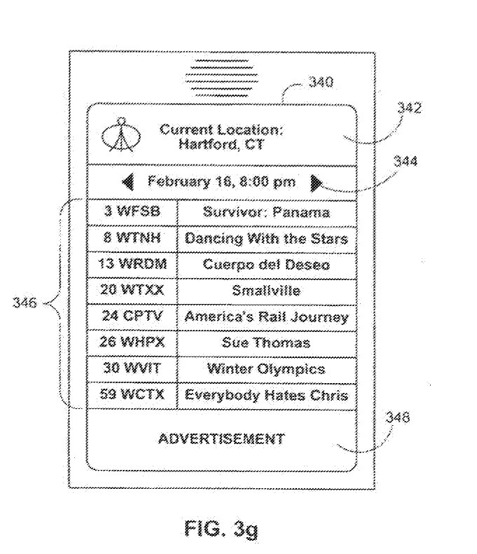

FIG. 3a shows an illustrative screen 300 of an interactive media guidance application implemented on mobile user equipment (e.g., mobile user equipment 108 (FIG. 1)) for providing a user with a menu in accordance with one embodiment of the present invention. Screen 300 may include a settings option 302 and a program listings option 304.

In response to the user selecting settings option 302, the interactive media guidance application may display a screen that allows the user to select, among other things, options for configuring location-based services. An illustrative settings screen is discussed in greater detail below.

In response to the user selecting program listings option 304, the interactive media guidance application may display a screen that includes program listings for a particular geographical region. Illustrative program listings screens are discussed in greater detail below.

Screen 300 may also include additional options, such as, for example, options for allowing the user to select the types of media information to retrieve (e.g., video-on-demand listings, pay-per-view listings, advertisements).

It should be understood by one skilled in the art that options 302 and 304 (and any other options displayed by the interactive media guidance application) may be selected using any suitable user input. For example, the display screen of the mobile user equipment may be touch sensitive and the options may be selected with, for example, a stylus. In another example, the user may use navigation keys on the keypad of the mobile user equipment to select options.

FIG. 3b shows an illustrative screen 310 of an interactive media guidance application implemented on mobile user equipment for selecting settings in accordance with one embodiment of the present invention. As shown in FIG. 3b, screen 310 includes checkboxes 312 and 314 and an OK button 316. Screen 310 may be displayed, for example, in response to the user selecting settings option 302 from screen 300 (FIG. 3a).

The interactive media guidance application may allow the user to select checkbox 312 to enable location-based services. In response to the user selecting checkbox 312, the interactive media guidance application may be configured to activate circuitry for determining the user's location. For example, the interactive media guidance application may activate a GPS sensor 218 (FIG. 2) on the mobile user equipment. In another example, the interactive media guidance application may instruct a network processor (e.g., server 130 or server 140 (FIG. 1)) to perform a network-based positioning method (e.g., triangulation, RF multipath fingerprinting, etc.) to determine the location of the mobile user equipment.

The interactive media guidance application may allow the user to select checkbox 314 to enable location-based updates of program listing information. In some embodiments, the interactive media guidance application may only allow the user to select checkbox 314 if the checkbox 312 has already been checked. In response to the user selecting checkbox 314, the interactive media guidance application may be configured to update program listings information based on the user's current location. In some embodiments, the interactive media guidance application may automatically update program listings information for the user's current location at periodic intervals. In response to automatically updating program listings information, the interactive media guidance application may display the updated program listing information to the user.

The interactive media guidance application may allow the user to select OK button 316 to save the settings selected by the user.

It should be understood by one skilled in the art that screen 310 may include additional options without departing from the scope of the present invention. For example, screen 310 may include options allowing the user to select settings relating to automatically updating program listings information at periodic intervals or receiving a user prompt to update the program listings information.

In another example, screen 310 may include options for allowing the user to select the amount of program listings information to retrieve when performing a location-based update (e.g., program listings for the next hour, program listings for the next six hours, program listings for favorite channels, etc.).

In another example, screen 310 may include options for allowing the user to select to update other types of media information or combinations of media information, including, for example, pay-per-view and video-on-demand listings, advertisements, etc.

FIG. 3c shows an illustrative screen 320 for displaying program listings information in an interactive media guidance application implemented on mobile user equipment in accordance with one embodiment of the present invention. Screen 320 includes location area 322, date/time area 324, program listings area 326, and advertisement area 328. Screen 320 may be displayed, for example, in response to the user selecting program listings option 304 from screen 300 (FIG. 3a).

Location area 322 includes information regarding the user's current location. The information may be displayed in any suitable format, such as, for example, city and state format, zip code format, area code format, latitude/longitude format, and any other suitable format or combination of formats. As mentioned above, in some embodiments, the mobile user equipment may include a GPS sensor (e.g., GPS sensor 218 (FIG. 2)). The GPS sensor may negotiate with one or more GPS satellites (e.g., GPS satellite 150 (FIG. 1)) to determine the location of the mobile user equipment. The interactive media guidance application may display the location of the mobile user equipment in a suitable format in screen 320. In some embodiments, the mobile user equipment may utilize a network-based positioning method (e.g., triangulation, RF multipath fingerprinting, etc.) to, determine the location of the mobile user equipment. A network processor (e.g., server 130 (FIG. 1)) may transmit to the mobile user equipment information regarding its location. In response, the interactive media guidance application may display the location of the mobile user equipment in a suitable format in screen 320.

Date/time area 324 indicates a time slot to which the program listings displayed in program listings display area 326 correspond. The time slot may be displayed in any suitable format. In some embodiments, the user may change the time slot by pressing directional keys on the mobile user equipment. As a result of the user changing the time slot, the interactive media guidance application may display program listings for the new time slot in program listings display area 326.

Program listings area 326 includes program listings for a plurality of television channels corresponding to a selected time slot and the user's current location. The interactive media guidance application may retrieve the program listings from a program listings database implemented on, for example, server 130 or server 140 (FIG. 1). The interactive media guidance application may allow the user to select one of the program listings to, for example, view information regarding the selected program, set a reminder for the selected program, set an audible reminder for the selected program, designate the channel on which the selected program is to be broadcast as a favorite channel, remotely schedule a recording of the selected program on a recording device, or perform any other suitable action.

Advertisement area 328 includes any suitable promotional or advertising information. In some embodiments, portions of the information may be selectable, allowing the user to order a related product, program, or service. For example, the user may navigate a highlight region using navigation keys on the mobile user equipment to advertisement area 328 to select promotional or advertising information.

In some embodiments, the promotional or advertising information may be selected based on the user's current location. For example, the interactive media guidance application may provide an advertisement database implemented on server 130 or server 140 (FIG. 1) with information regarding the user's current location and the advertisement database may provide suitable location-based advertisements to the interactive media guidance application for display.

FIGS. 3d-f show an illustrative screen 330 of an interactive media guidance application implemented on mobile user equipment for displaying the status of program listing information updates in accordance with one embodiment of the present invention. Screen 330 includes a listing of tasks that is displayed as the tasks are being performed by the interactive media guidance application. Screen 330 may be displayed in response to the user changing his location to a location that receives different television programming or the user prompting the interactive media guidance application to retrieve program listings information for the user's current location.

As shown in FIG. 3d, one of the task listings indicates that the interactive media guidance application is detecting the user's new location. In some embodiments, a GPS sensor in the mobile user equipment on which the interactive media guidance application is implemented may interact with one or more GPS satellites to pinpoint the user's current location. In some embodiments, the network may perform triangulation, RF multipath fingerprinting, or any other suitable technique to determine the user's current location and send information regarding the user's current location to the mobile user equipment.

The interactive media guidance application may display another task listing in screen 330 that indicates that the interactive media guidance application is retrieving local program guide information.

The information regarding the user's current location may be converted into a format that is accepted by the database on which program listings information is stored (e.g., server 140 (FIG. 1)). For example, if the program listings database organizes program listings information by ZIP code, the information regarding the user's current information may be converted into a ZIP code and transmit the ZIP code to the program listings database. The conversion may be performed by the interactive media guidance application if, for example, a GPS sensor determines the user's current location. The conversion may be performed by a network processor (e.g., server 130 or server 140 (FIG. 1)) if, for example, the network uses triangulation or RF multipath fingerprinting to determine the user's current location.

As shown in FIG. 3e, the interactive media guidance application may display dialog box 332 if the program listings database indicates that more than one service provider offers television programming at the user's current location.

Dialog box 332 may include service provider options 334, checkbox 336, and OK button 338. Service provider options 334 may allow the user to select a service provider for which to retrieve program listings information.

Dialog box 332 may also include checkbox 336 that the user may select to save the user's preference for the current location. If the user selects one of service provider options 334 and checkbox 336, the interactive media guidance application may be configured to automatically retrieve program listings information for the selected service provider the next time the user returns to the current location.

In response to the user selecting OK button 338, the interactive media guidance application may initiate retrieval of the program listings information for the selected service provider. The interactive media guidance application may also remove dialog box 332 from screen 330. In some embodiments, the interactive media guidance application may transmit the user's current location to the server on which the program listings information is stored. In some embodiments, a network processor may determine the user's current location and transmit the user's current location to the server on which the program listings information is stored. The interactive media guidance application may store the retrieved program listings information on any suitable memory element on the mobile user equipment (e.g., internal memory, removable media, etc.).

As shown in FIG. 3f, the interactive media guidance application may display another task listing in screen 330 that indicates that the interactive media guidance application is updating the program listings information. In some embodiments, the interactive media guidance application may archive the program listings information for the user's previous location in memory. In some embodiments, the archived program listings information may be used to locally update program guide settings if the user returns to a previous location. In some embodiments, the archived program listings information may be accessed by the user while the user is away from the previous location.

The interactive media guidance application may update the program listings information such that the program listings information for the user's current location is displayed in response to a request to display program listings information. After the interactive media guidance application has finished updating the program listings information, the interactive media guidance application may return to the screen that was displayed prior to screen 320.

FIG. 3g shows an illustrative screen 340 of an interactive media guidance application implemented on mobile user equipment for displaying program listings information in accordance with one embodiment of the present invention. Screen 340 includes, for example, updated location area 342, date/time area 344, updated program listings area 346, and advertisement area 348. Screen 340 also include any other suitable area or combination of areas. Screen 340 may be displayed, for example, in response to the interactive media guidance application updating program listings information based on the user's location.

Updated location area 342 indicates the user's current location as determined by or communicated to the mobile user equipment. Date/time area 344 indicates a time slot for the updated program listings displayed in updated program listings area 346. In some embodiments, the time slot displayed in date/time area 344 may be the same time slot that was displayed prior to the update of program listing information. In some embodiments, the time slot displayed in date/time area 344 may be the current time slot. Updated program listings area 346 includes program listings for the user's current location provided by the selected service provider. Advertisement area 348 includes advertising or promotional information.

It should be understood that screens 300, 310, 320, 330, and 340 (FIGS. 3a-g) are merely illustrative and that these screens may include additional areas and/or information without departing from the scope of the present invention.

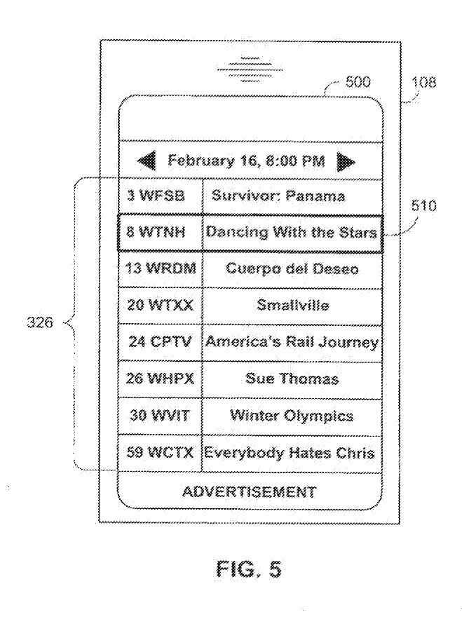

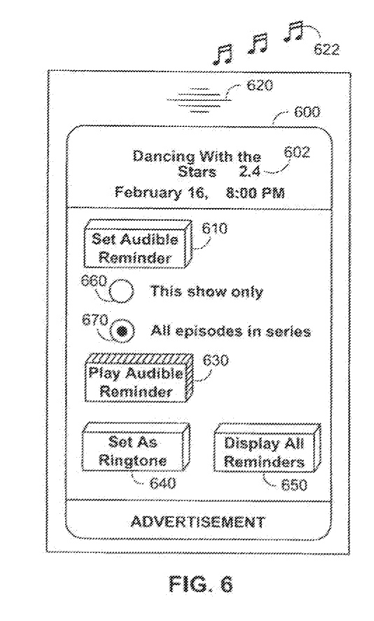

FIG. 4 is an illustrative flow diagram 400 for generating an audible reminder on mobile user equipment 108 in accordance with an embodiment of the present invention. At step 410, a user input identifying a video may be received. For example, as shown in FIG. 5, program listings area 326 may be included in display 500 on mobile user equipment 108 (or mobile device). The user may identify a video for which to set an audible reminder by positioning cursor 510 over one of the displayed listings (e.g., “Dancing with the Stars”). Included with each listing may be an identifier (not shown) that indicates to the user whether the program is in a series of programs. This may allow the user to automatically identify all the episodes associated with that particular series of programs. This will be described in more detail in connection with FIG. 6.

The user may alternatively identify a number of videos by using a keyword or genre. For example, the user may be presented with a screen that allows the user to input a keyword that identifies a number of programs (e.g., the title or a portion thereof of one or more videos of interest). For example, the user may input keyword “idol” and in response any video with a matching keyword in, for example, its title will be identified. A listing (not shown) of the videos identified by the keyword may be displayed. And, the user may subsequently select a subset of the displayed videos for which to set an audible reminder. Alternatively, the user may select a particular genre (e.g., Action) and a number of videos that correspond to that genre may be identified and displayed. The user may also select a subset of the videos that correspond to the particular genre for which to set an audible reminder.

Referring back to FIG. 4, at step 420, an audible reminder may be set for the identified video. For example, as shown in FIG. 6, an audible reminder display 600 may be provided to set an audible reminder for the identified video. For example, as shown in display 600, the identified video (e.g., “Dancing with the Stars”) is displayed with the date and time at which the video may be broadcast. Display 600 also provides a series identifier 602 (e.g., “2.4”) indicating to the user that the identified video may be in a series of videos. For example, the identified video may be the fourth episode in the particular series of episodes.

The user may set audible reminders for the identified video or a number of related videos or programs. For example, the user may select the this show only option 660 to set an audible reminder only for this broadcast of the show. Alternatively, if the user desires to set an audible reminder for all episodes in the series, the user may select all episodes in series option 670. The default option may be the selection of all episodes in series option 670. However, the user may freely change the system defaults.

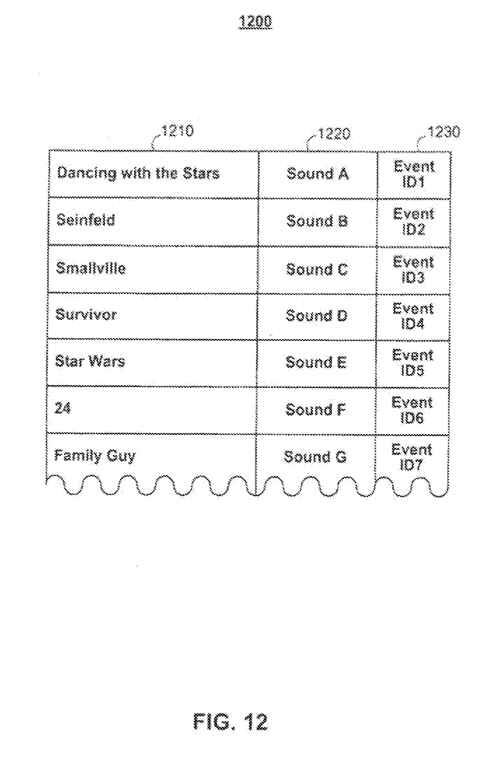

Referring back to FIG. 4, at step 430, an audio signal that identifies the video when heard by the user may be retrieved from a database of audio signals. Mobile device 108 may receive the audio signal from a database of audio signals (described below in more detail in connection with FIG. 12) and store the audio signal associated with the identified video. Alternatively, mobile device 108 may have its memory preprogrammed with a number of audio signals. The audio signal may then be retrieved from the preprogrammed memory. In another embodiment, mobile device 108 may receive the audio signal in an MMS message from a remote device at a predetermined time.

The user may select the play audible reminder option 630 to listen to a sample of the audio signal. The audio signal may be retrieved from the memory and played through the speaker 620 on mobile user equipment 108. The user may hear the sound 622 generated by the speaker and may associate the sound generated by the speaker with the identified video. The audio signal may specifically be the theme song of the identified video. However, other sounds that identify the video may be used (e.g., sounds that are unique to the content of the broadcast or voices of actors that are in the video).

The user may also select the set as ringtone option 640. Selecting set as ringtone option 640 may replace the ringtone of mobile user equipment 108 with the audio signal that may be stored on the device. Setting the audio signal as the default ringtone may cause speaker 620 to generate the sound 622 associated with the audio signal when a call is received at mobile user equipment 108.

Referring back to FIG. 4, at step 440, a check for the predetermined time is performed. If the predetermined time is determined, at step 450, the audible reminder may be generated from the retrieved or stored audio signal, such that the sound identifies the video to the user when heard by the user. For example, after the user has selected the set audible reminder option 610, mobile user equipment device 108 may store the audible reminder settings and generate the audible reminder at a predetermined time. The predetermined time may be a few minutes before the video is broadcast or any other suitable time frame (e.g., the broadcast time of the video). For example, at or around 8 PM on February 16, the audio signal associated with the identified video (e.g., “Dancing with the Stars”), may be generated by speaker 620 to produce sound 622 that identifies the video to the user when the user hears the sound. As described above, the audio signal may be received at the predetermined time from a remote device in an MMS message. The mobile device may generate the audio signal in the MMS message to identify the video to the user.

An advantage of this functionality, is that the phone does not have to be in visible proximity to the user for the user to receive the alert of the video broadcast. For example, mobile user equipment 108 may be in the user's pocket and at a predetermined time may generate the audible reminder for the identified video. Without looking at the phone (or opening the phone), the user may be alerted and informed that the identified video is about to begin. For example, the user may hear the sound associated with the identified video and recall that an audible reminder was set for that particular video. The user may tune to the video broadcast (on the phone or another user device).

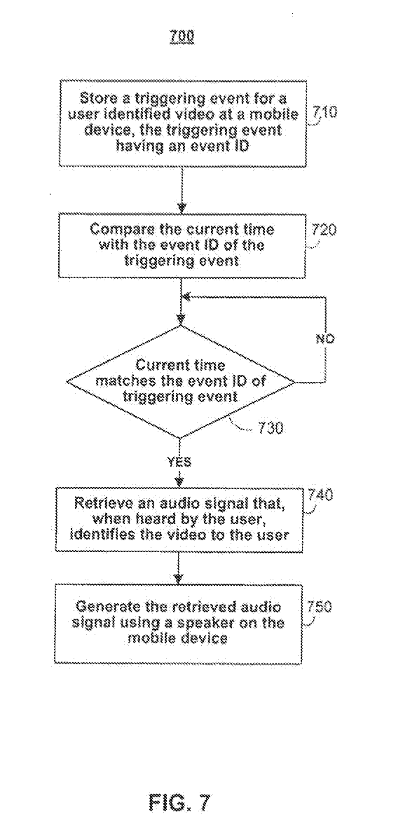

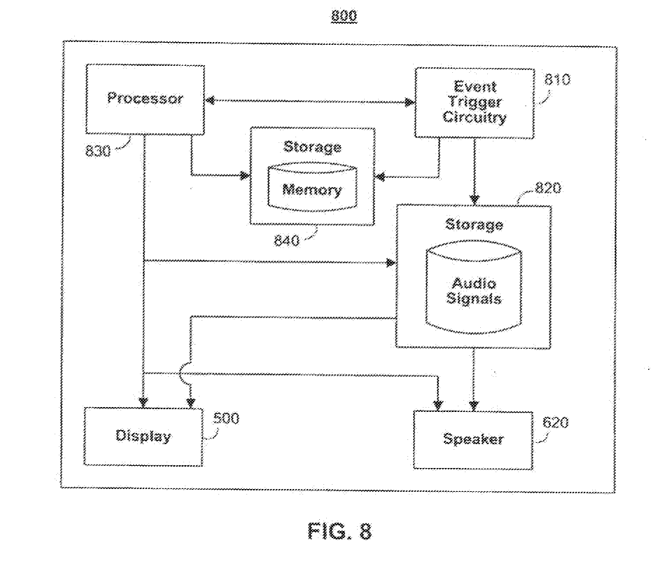

FIG. 7 is an illustrative flow diagram 700 for generating an audible reminder on mobile user equipment 108 in accordance with an embodiment of the present invention. At step 710, a triggering event for a user identified video may be stored at mobile user equipment 108, the triggering event may include an event ID. For example, as shown in FIG. 8, the system 800 for mobile user equipment 108 may include a processor 830, a memory 840, display 500, speaker 620, an event trigger circuitry 810 and a database of audio signals 820. The triggering event may be stored in memory 840. Although memory 840 and database of audio signals 820 have been drawn separately, it should be understood that they may be included within the same storage unit. Also it should be understood that the functionality in memory 840 and database of audio signals 820 may be interchangeable and their functionality depends on what is stored in either one. It should also be understood that any storage unit drawn in any of the other figures may provide the functionality of either or both memory 840 and database of audio signals 820.

Event trigger circuitry 810 may be configured with the triggering event and event ID. The triggering event ID may be for example, a broadcast date/time of the video. Alternatively, in another embodiment (described in more detail below) the triggering event may be the receipt of a message such as a Multimedia Message Service (MMS) message, a text message, or any other form of message or indication signal that the event trigger circuitry is configured to receive and generate an internal event trigger.

Referring back to FIG. 7, at step 720, the current time may be compared with the event ID of the triggering event. For example, event trigger circuitry 810 may include a clock and compare circuitry. It should be understood that a clock signal or trigger event signal may instead be received from another portion of user mobile equipment system 800, for example the clock signal used to operate the processor may be used. The clock signal may be compared to the event ID that may be stored in memory 840 or configured in event trigger circuitry 810.

At step 730, a check is performed to determine whether the current time matches the event ID. If a match is found, at step 740, an audio signal that, when heard by the user, identifies the video to the user may be retrieved. For example, when event trigger circuitry 810 determines that the compare operation results in a match (or in other embodiments a triggering message was received), event trigger circuitry 810 may provide the necessary signals to processor 830. For example, event trigger circuitry may provide an IRQ (interrupt) to the processor which may then execute code for processing the particular event. Processor 830 may assist event trigger circuitry 810 with processing the results of the compare operation. Event trigger circuitry 810 or processor 830 may retrieve from the memory 840 or the database of audio signals 820, the audio signal that identifies the video to the user when the user hears it.

The audio signal retrieval may be performed by using the event ID or some other identifier to look up in the memory or database of audio signals 820 the audio signal that is associated with the event ID of the triggered event. For example, the event ID may include the date/time of a video. As shown in FIG. 12, a subset of database entries 1200 in database of audio signals 820 may include fields corresponding to the video title 1210, the audio signal that identifies the video to the user 1220, and the event ID 1230. The database of audio signals 820 may be searched for a audio signal matching the particular date/time or event ID of the identified video. When a video match is found, the associated audio signal may be read or retrieved from the audio signal entry field 1220. This audio signal may then be provided to another component in system 800 and in particular to speaker 620.

Referring back to FIG. 7, at step 750, the retrieved audio signal may be generated using the speaker on the mobile device. For example, speaker 620 may receive the audio signal and produce sound 622 (FIG. 6) that, when heard by the user, identifies the video to the user.

It has been shown that a user may identify a video for which to set an audible reminder. And, the system at a predetermined time (e.g., the broadcast time of the video) may generate an audio signal that identifies the video to the user. The video may be displayed on user mobile equipment 108 using display 500. Alternatively, mobile user equipment 108 may act as a remote control and produce a signal that tunes another device (e.g., television equipment) to the identified video when or substantially around the time the audio signal is generated. This may eliminate the need for the user to manually tune to the particular video at the appropriate time when display 500 may not be configured to display the video.

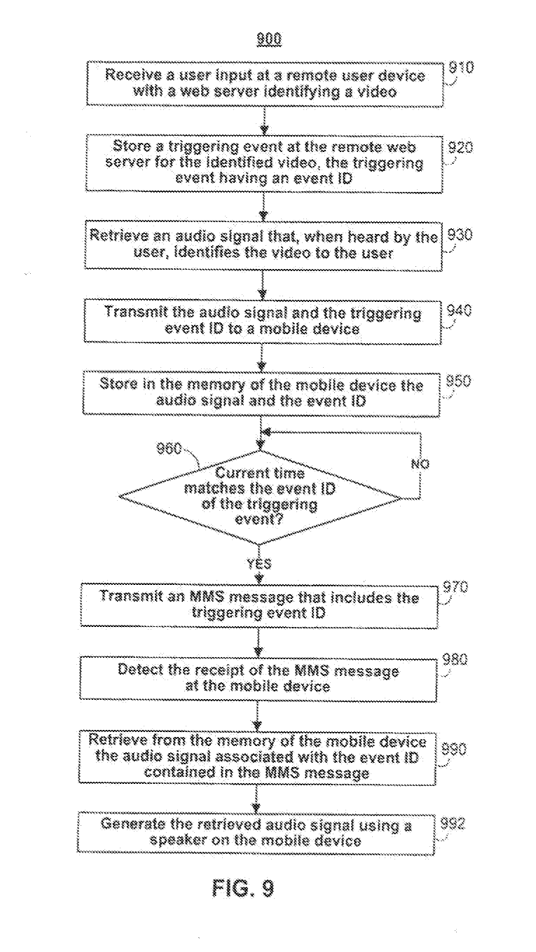

In some embodiments, the audio signal associated with the identified video may be provided by a remote device to the mobile device prior to the predetermined time of the audible reminder. This may allow the user to access or play the audio signal prior to the triggering event. When the predetermined time of the audible reminder is reached (e.g., the triggering event has been detected), a message in the form of an MMS or text may be transmitted to the mobile device to instruct the mobile device to access the audio signal. This may alert the user of the broadcast of the identified video. This is described below in connection with FIG. 9.

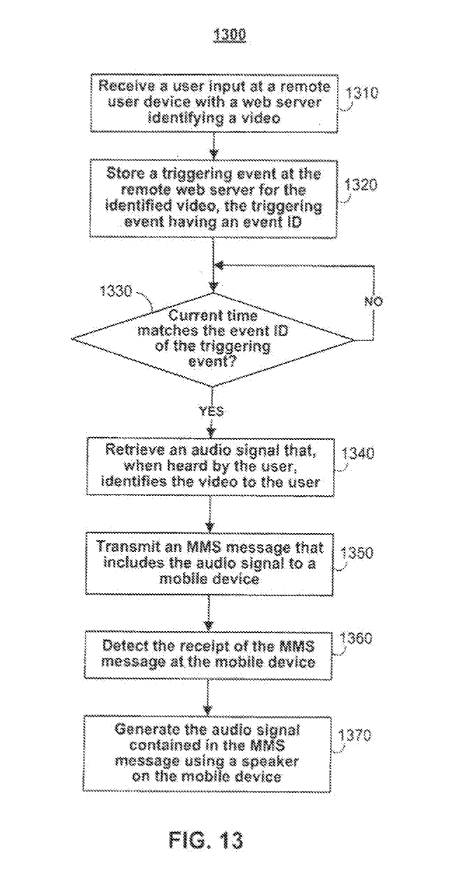

In some other embodiments, the audible reminder may be set at the remote device. And, the remote device may transmit in one message the audio signal associated with the identified video and the instruction to generate the audible reminder. The mobile device may store the audio signal and generate the audible reminder from the received message. This will be described in more detail in connection with FIG. 13.

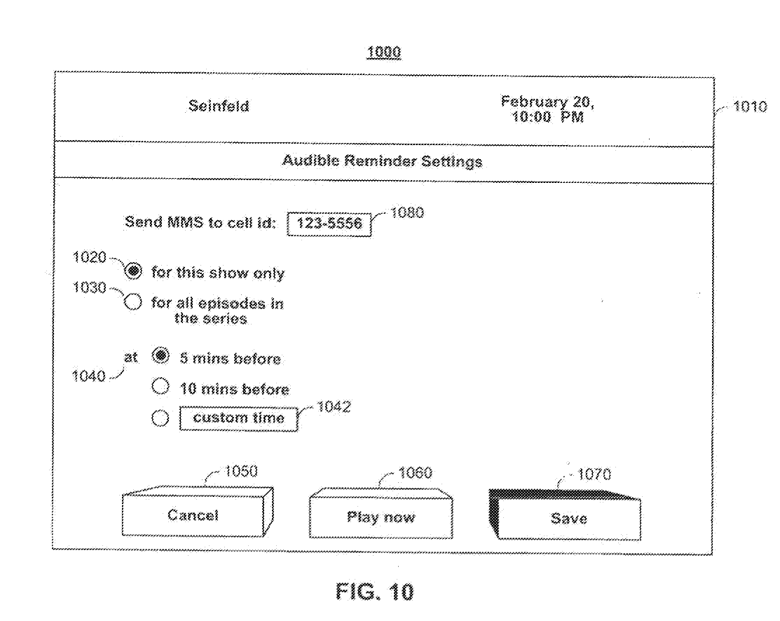

FIG. 9 is an illustrative flow diagram 900 for setting an audible reminder at a remote device and generating the reminder on mobile user equipment 108 in accordance with an embodiment of the present invention. At step 910, a user input identifying a video may be received at a remote device. For example, screen 500 (FIG. 5) may be provided to a user at a remote device. As described above, a user may navigate a cursor to highlight a listing or video for which to set an audible reminder. Alternatively, the user may input a keyword or genre and receive multiple listings or videos corresponding to the user input. The user may then select a subset of the listings and set audible reminders for the selected subset. As shown in FIG. 10, a display 1000 may be provided to the user after the user identifies a video for which to set an audible reminder. For example, the identified video 1010 (e.g., “Seinfeld”) may be displayed with the date/time at which it may be broadcast.

Screen 1000 may allow the user to configure various settings for the audible reminder. For example, if the video is part of a series of videos that user may select option 1020 to set an audible reminder for only the identified video 1010. Alternatively, the user may select option 1030 to set an audible reminder for all of the episodes that are part of the series of the identified video 1010.

The user may also select the time at which to generate the audible reminder. For example, by selecting one of the trigger options 1040, the audible reminder may be set to be generated five minutes before the broadcast time of the identified video 1010 (e.g., five minutes prior to 10 PM on February 20) or ten minutes before the broadcast time. Alternatively, the user may select a custom time 1042 at which to have the audible reminder generated for the identified video 1010.

The cancel option 1050 allows the user to exit out of screen 1000 and prevent the audible reminder from being saved.

Referring back to FIG. 9, at step 920, the triggering event may be received at the remote device for the identified video, the triggering event may include an event ID. For example, as shown in screen 1000 (FIG. 10), after the user has completed setting options regarding the audible reminders, the user may select the save option 1070 to cause the audible reminder to be stored on the remote device. The remote device may configure various circuitry to generate the audible reminder or set off a trigger when the event ID is detected in accordance with the user set options.

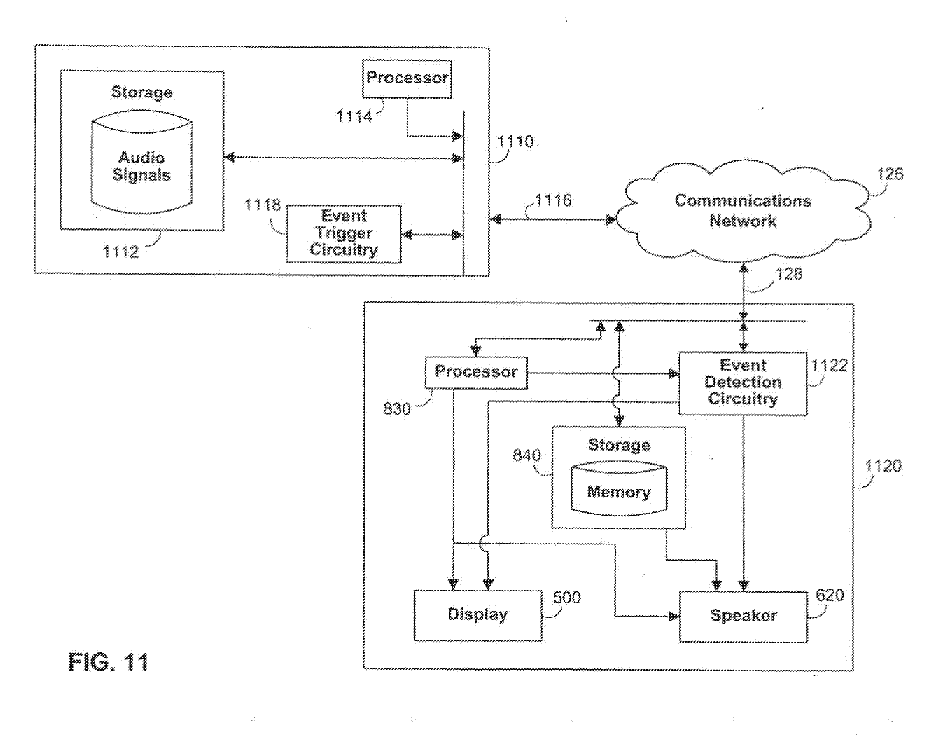

For example, as shown in FIG. 11, a remote device 1110, may receive the triggering event and configure an event trigger circuitry 1118 with the triggering event. Event trigger circuitry 1118 may inform the processor 1114 when the configured event detected.

At step 930, an audio signal that identifies the video to the user may be retrieved. For example, processor 1114 may retrieve (using the event ID or some other identifier) the audio signal that identifies the video to the user from the database of audio signals 1112. As described above, in connection with FIG. 12, this task may be performed by comparing various event IDs stored in field 1230 in database of audio signals 1112 with the event ID of the identified video. Alternatively, this may also be performed by comparing the titles of the identified video with those stored in fields 1210. The audio signal associated with the identified video may be retrieved from field 1220.

The sound of the audio signal that is retrieved may be sampled by selecting the play now option 1060 in screen 1000 (FIG. 10).

At step 940, the audio signal and the triggering event ID may be transmitted to the mobile device. For example, the user may enter the identification of the mobile device (e.g., telephone number) using interactive entry field 1080 (FIG. 10). The identification of the mobile device may also be preconfigured or stored to avoid having to repeat this step for every audible reminder that the user desires to set. Alternatively, remote device may prompt the user with a list of available mobile device identifications. The user may select one or more mobile devices from the list and the remote device may transmit the audio signal and the triggering event ID to each of the selected mobile devices.

The audio signal and the triggering event ID may be communicated from remote device via path 1116 and communications network 126 to the mobile device 1120. It should be understood that communications network 126 may be any short range or long range path. For example, the data may be communicated via Bluetooth, wireless, internet, infrared, or any other suitable medium or any combination of the same.

Referring back to FIG. 9, at step 950, the audio signal and the event ID may be stored on the mobile device. For example, mobile device 1120 may receive the audio signal and event ID via path 128 and store the audio signal and event ID in memory 840. This may allow a user of mobile device 1120 to access the audio signal and play the sound associated with the audio signal through speaker 620. Also, the user may select an option (not shown) to view all of the reminders that may be set on mobile device 1120 or remote device 1110 by retrieving the event ID associated with each audio signal. The event ID, as described above, may include the date/time of the broadcast of the identified video. A listing of the stored event IDs may be provided in display 500.

At step 960, the current time is compared to the event ID. If the current time matches the event ID, at step 970 an MMS message that includes the triggering event ID may be transmitted to the mobile device. For example, event trigger circuitry 1118 may operate in a similar manner as event trigger circuitry 810 (FIG. 8). Event trigger circuitry 1118 may include a clock that may be compared against the event ID to determine whether the time to generate the audible reminder for the identified video has arrived. Event trigger circuitry 1118 may provide the results of the compare operation to processor 1114 (by for example an IRQ (interrupt)). Processor 1114 may then generate an MMS or any other suitable message (e.g., text message) that includes the event ID (of the event triggered by event trigger circuitry 1118). Mobile device 1120 may receive the MMS or text message from remote device 1110 via communications network 126.

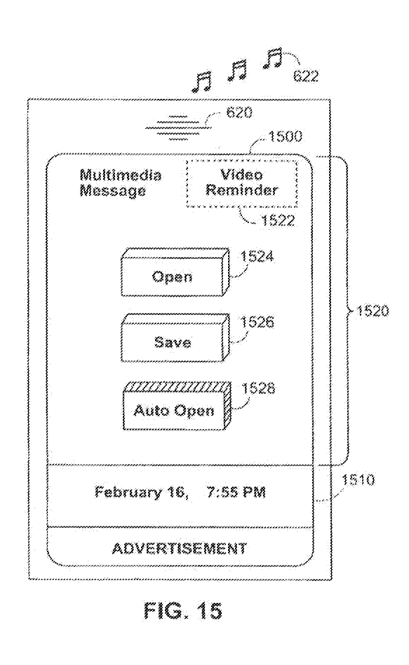

At step 980, the receipt of the MMS message may be detected at the mobile device. For example, event detection circuitry 1122 may be configured to detect the MMS or text message transmitted from remote device 1110. Event detection circuitry 1122 may extract the information from the MMS or text message and in particular may determine the event ID of the event triggered by event trigger circuitry 1118. Event trigger circuitry 1122 may provide this information to display 500 and processor 830. The MMS or text message may be displayed as shown for example in the screen 1500 of FIG. 15, described below in more detail. Event trigger circuitry 1122 may also generate a sound associated with the receipt of the MMS or text message through speaker 620. This sound may be the same or different from the audio signal associated with the identified video. For example, the user may set up a default sound to be generated upon receipt of an MMS or text message. The user, may select any sound stored in memory 840 (including any stored audio signals) to be associated with the receipt of the MMS or text message. Similarly, the user may select any sound to be the default ringtone of the mobile device 1120, such that when a call is received the selected sound will be generated by speaker 620.

At step 990, the audio signal associated with the event ID contained in the MMS message may be retrieved from the memory of the mobile device or accessed directly from the MMS message. For example, processor 830 may retrieve from the memory the audio signal of the triggered event by performing a look up of the event ID (received in the MMS or text message) in memory 840.

At step 992, the retrieved audio signal may be generated using the speaker on the mobile device. For example, memory 840 and processor 830 may cause speaker 620 to generate the sound associated with the audio signal (retrieved from memory 840) of the triggered event.

When the user hears this sound, the user is notified (without necessarily looking at mobile device 1120) that the identified video is about to be broadcast (depending on the how much lead time the user selected to have before broadcast using trigger option 1040 (FIG. 10)). For example, the user may recall the setting an audible reminder. And, the user may associate that audible reminder (or audio signal of the audible reminder) precisely with a video that the user previously identified. The user may then tune to the identified video.

It should be understood that remote device 1110 may also be another mobile device 1120 without departing from the scope and spirit of the invention.

FIG. 13 is an illustrative flow diagram 1300 for setting an audible reminder at a remote device and generating the reminder on mobile user equipment 108 in accordance with another embodiment of the present invention. At step 1310, a user input may be received at a remote device identifying a video. For example, as described above in connection with FIG. 5, screen 500 may be displayed to a user at a remote device. The user may navigate a cursor to highlight a listing or video for which to set an audible reminder.

At step 1320, a triggering event may be received at the remote device for the identified video, the triggering event having an event ID.

At step 1330, the current time is compared to the event ID of the triggering event. If the current time matches the event ID of the triggering event, at step 1340, an audio signal that identifies the video to the user (when heard by the user) may be retrieved. For example, event trigger circuitry 1118 (FIG. 11) may include a clock that may be compared against the event ID to determine whether the time to generate the audible reminder for the identified video has elapsed. Event trigger circuitry 1118 may provide the results of the compare operation to processor 1114 (by for example an IRQ (interrupt)). Processor 1114 may retrieve from database of audio signals 1112 (FIG. 11) the audio signal that is associated with the event ID of the event triggered by trigger circuitry 1118. This may be performed for example by searching event ID field 1230 in database 1200 for an event ID matching the event ID of the identified video. Once found, the audio signal may be retrieved from the database by reading the corresponding sound field 1220 in database 1200.

At step 1350, an MMS message may be transmitted to the mobile device that includes the audio signal. Processor 1114 may generate an MMS message that includes the audio signal retrieved from database of audio signals 1112 (of the event triggered by event trigger circuitry 1118). Mobile device 1120 may receive the MMS from remote device 1110 via communications network 126.

At step 1360, the receipt of the MMS message may be detected at the mobile device. For example, event detection circuitry 1122 (FIG. 11) may be configured to detect the MMS message transmitted from remote device 1110. Event detection circuitry 1122 may extract the audio signal from the MMS message. Event trigger circuitry 1122 may generate a sound associated with the receipt of the MMS message through speaker 620. As described above, this sound may be the same or different from the audio signal associated with the identified video. For example, the audio signal extracted from the MMS message may be stored in memory 840 of mobile device 1120 for any use local to mobile device 1120.

At step 1370, the audio signal contained in the MMS message may be generated using a speaker on the mobile device. Event trigger circuitry 1122 or processor 830 may cause speaker 620 to generate a sound associated with the extracted audio signal. This sound when heard by the user identifies the video (corresponding to the audible reminder) to the user.

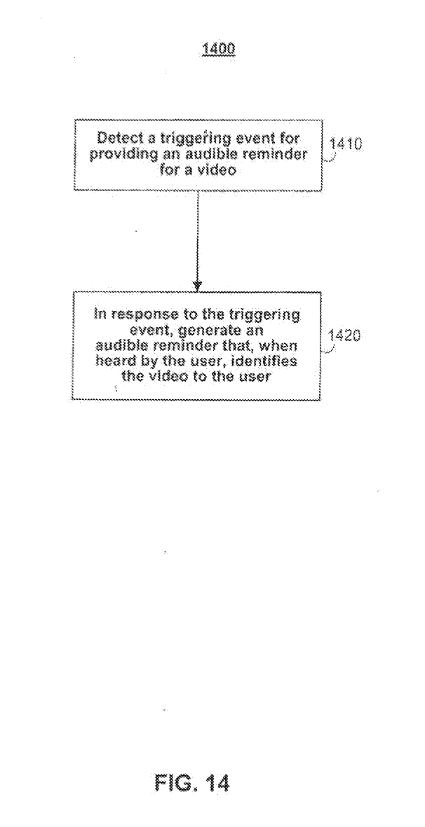

Alternatively, the audio signal of the audible reminder may be provided to the mobile device at the predetermined time of the identified video (e.g., the broadcast time). This is described below in connection with FIG. 14.

FIG. 14 is an illustrative flow diagram 1400 for generating an audible reminder in accordance with another embodiment of the present invention. At step 1410, a triggering event for providing an audible reminder for a video may be detected. For example, referring back to FIGS. 8 and 11, event trigger circuitry 810 and 1118 may detect a triggering event. The triggering event may be associated with a video identified by the user for which to set an audible reminder.

At step 1420, an audible reminder that, when heard by the user, identifies the video to the user may be generated in response to the triggering event. For example, as shown in FIG. 15, an MMS message may be received by mobile device 108. Mobile device 108 may generate sound 622 (that may be included in the MMS message) using speaker 620 that when heard by the user identifies the video to the user. Also, the MMS message 1520 may displayed on screen 1500.

The user may instruct mobile device 108 using auto open option 1528 to immediately access (play) the contents included in the MMS message. For example, MMS message 1520 may include a video reminder identifier 1522 that indicates to the user and mobile device 108 that the MMS message relates to an audible reminder for a user identified video. Identifier 1522 may be read by circuitry on mobile device 108 prior to its display and may instruct mobile device 108 to generate the audio signal included in the message automatically. Thus, whenever mobile device 108 receives an MMS message relating to an audible reminder (for a video), mobile device 108 will immediately open and access or play the contents included in the MMS message. Thereby, the sound may be generated that the user associates with a particular identified video whenever the user hears it.

Screen 1500 may also include a display 1510 providing the current date/time. The user may use this information to know how much time is left before the identified video is broadcast. The user may also select the open option 1524 to access or play the contents MMS message 1520. This option may be provided if the auto option was not selected by the user. The user may also select the save option 1526 to store the audio signal included in MMS message 1520 to the memory on mobile device 108 for later use. For example, by storing the audio signal included MMS message 1520, the user may select to access or play the audio signal at a later time or set the audio signal as the default ringtone of mobile device 108.

It should be understood that screens 500, 600, 1000, 1500 (FIGS. 5, 6, 10, 15) are merely illustrative and that these screens may include additional areas and/or information without departing from the scope of the present invention.

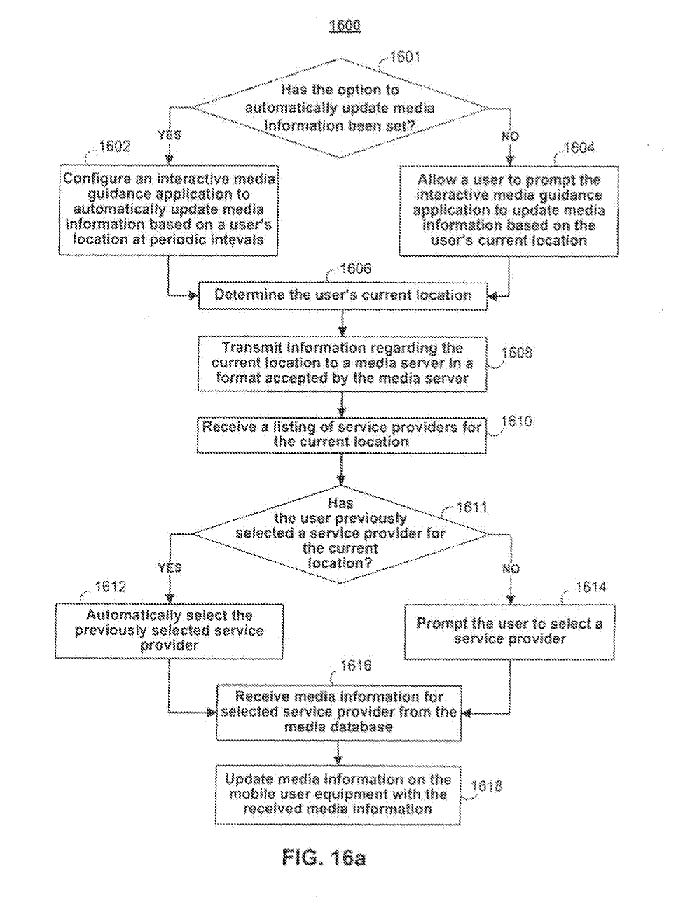

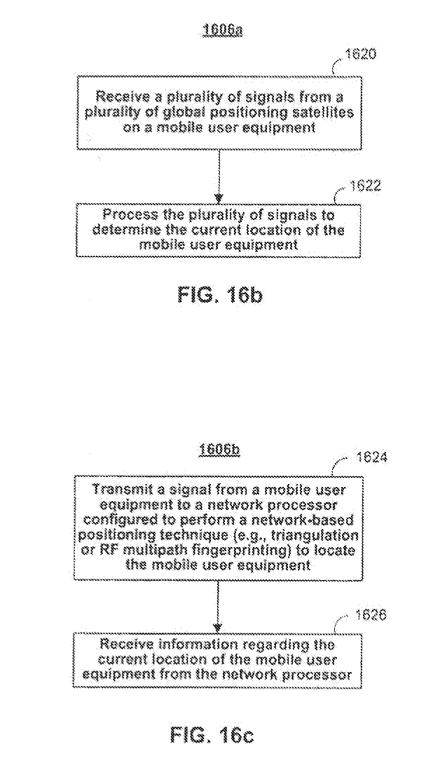

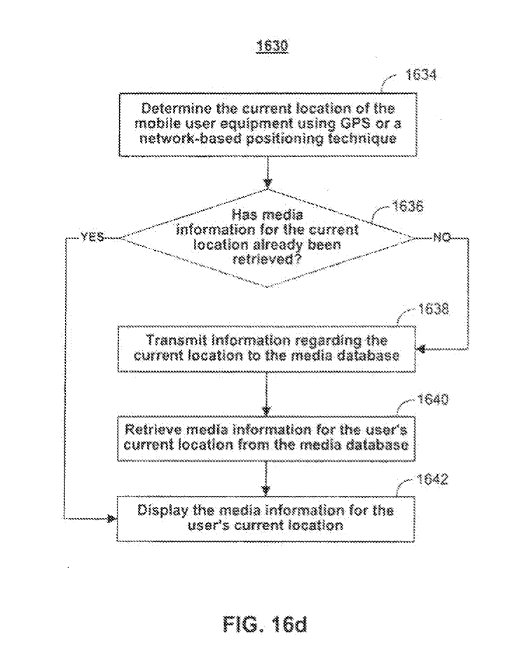

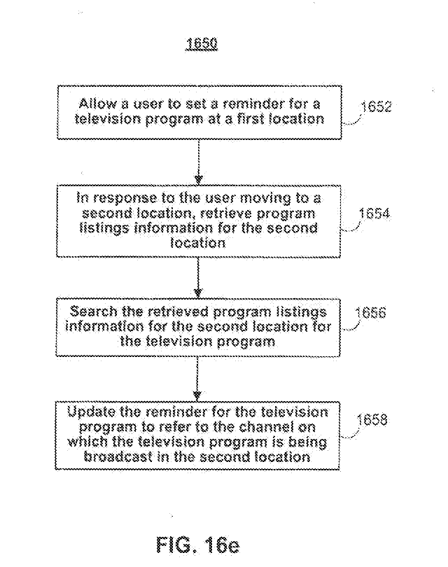

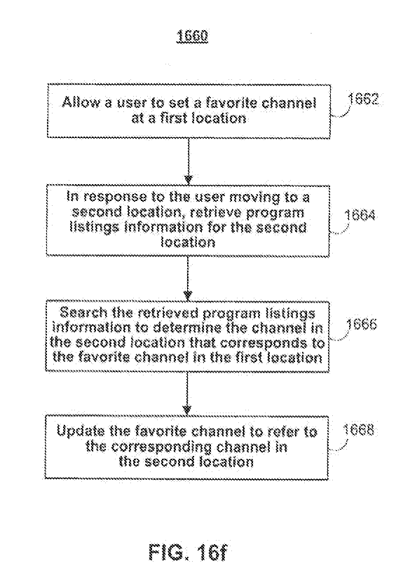

FIG. 16a is an illustrative flow diagram 1600 for using an interactive media guidance application implemented on mobile user equipment to retrieve program listings information based on a user's current location in accordance with one embodiment of the present invention.

At step 1601, the interactive media guidance application may determine whether an option to automatically update program listings information has been set. For example, the user may select an option displayed in a settings screen (e.g., screen 310 (FIG. 3b)) that configures the interactive media guidance application to automatically update media information based on the user's location. The user may also select a periodic interval for performing updates of media information in the settings screen.

At step 1602, the interactive media guidance application is configured to automatically update media information based on a user's location at periodic intervals. The interactive media guidance application may determine the amount of time elapsed since the last update of media information and compare the elapsed time with the selected periodic interval. Once the elapsed time exceeds the selected interval, the interactive media guidance application initiates an update of media information.

Alternatively, at step 1604, the interactive media guidance application is prompted by the user to update media information based on the user's current location. For example, the user may press a dedicated key to initiate an update of media information.

At step 1606, the interactive media guidance application determines the user's current location. In some embodiments, the mobile user equipment may include a GPS sensor that is configured to determine the user's current location. This approach is discussed in greater detail in connection with FIG. 16b. In some embodiments, a network processor (e.g., server 130 or server 140 (FIG. 1)) may perform a network-based positioning technique (e.g., triangulation or RF multipath fingerprinting) to determine the user's current location. This approach is discussed in greater detail in connection with FIG. 16c.

At step 1608, the interactive media guidance application transmits information regarding the user's current location to a media database in a format accepted by the media database. For example, if the mobile user equipment has determined the user's current location using GPS, the mobile user equipment may transmit information regarding the user's location to the media database. In another example, if the network processor has used a network-based positioning technique to determine the user's current location, the network processor may transmit information regarding the user's location to the media database. Alternatively, the network processor may send the information to the mobile user equipment for relaying to the media database. The media database may be implemented on server 130 or server 140 (FIG. 1). In some embodiments, the media database may aggregate media information for a plurality of service providers. In some embodiments, the network processor may be configured to access media information based on location from the media database. In this approach, the network processor is not required to communicate the user's location to the media database.

The interactive media guidance application may convert information regarding the user's current location into a format that is accepted by the media database as a search parameter. For example, if the GPS sensor has provided the user's location in a latitude/longitude format and the media database accepts ZIP codes, the interactive media guidance application may determine the ZIP code corresponding to the latitude and longitude for the user's current location. In particular, the interactive media guidance application may send a request to a server to convert the location information to a ZIP code or the interactive media guidance application may perform the conversion by referring to data correlating latitude and longitude information with ZIP codes.

At step 1610, if there is more than one service provider for the user's current location, the interactive media guidance application may receive a listing of service providers for the user's current location. Service providers may include broadcast, cable, satellite providers, fiber optic, online, and any other suitable service providers.

At step 1611, the interactive media guidance application may determine whether the user has previously selected one of the service providers for the current location.

At step 1612, if the user has previously selected one of the service providers for the current location, the interactive media guidance application automatically selects the previously selected service provider from which to receive media information. For example, the user may currently be located in Minneapolis, Minn. If the user was in Minneapolis a week ago and previously selected to receive media information for television broadcast providers, the interactive media guidance application may automatically select to receive media information for television broadcast providers in accordance with the user's previous selection.

In some embodiments, the user may select to receive media information for a service provider for all locations. The interactive media guidance application may automatically select to receive media information for the default service provider.

Alternatively, at step 1614, if the user has not previously selected one of the service providers for the user's current location, the interactive media guidance application prompts the user to select a service provider for which to receive media information. For example, as shown in FIG. 3e, the interactive media guidance application may display a dialog box prompting the user to select a service provider for which to receive media information.

At step 1616, the interactive media guidance application may receive media information for the selected service provider from the media database. For example, if the media database is a program listings database, the interactive media guidance application may receive program listings information for the user's current location. If the media database is an advertisement database, the interactive media guidance application may receive advertisements targeted for the user's current location.

At step 1618, the interactive media guidance application may update the media information on the mobile user equipment with the received media information. For example, a program listings screen may be updated with the program listings received from the media database.

FIG. 16b is an illustrative flow diagram 1606a for determining the user's current location using a GPS sensor implemented on mobile user equipment in accordance with one embodiment of the present invention.

At step 1620, the mobile user equipment receives a plurality of signals from a plurality of global positioning satellites 150 (FIG. 1). As shown in FIG. 2, the mobile user equipment may include GPS sensor 218 for receiving signals from GPS satellites 150.

At step 1622, the GPS sensor processes the received signals to determine the current location of the mobile user equipment. In particular, the GPS sensor may determine the distance to GPS satellites 150 and perform trilateration to determine its precise location.

FIG. 16c is an illustrative flow diagram 1606b for determining the user's current location using a network-based positioning technique in accordance with one embodiment of the present invention.

At step 1624, a signal is transmitted from a mobile user equipment to a network processor (e.g., server 130 or server 140 (FIG. 1)). The network processor may analyze the characteristics of the transmitted signal to determine the user's current location. In some embodiments, the network processor triangulates the radio emissions from the mobile user equipment. In some embodiments, the network processor performs RF multipath fingerprinting in which the fingerprint of the transmitted signal is measured and compared to the fingerprints of test signals whose origins are known.

At step 1626, the interactive media guidance application receives information regarding the current location of the mobile user equipment from the network processor.

FIG. 16d is an illustrative flow diagram 1630 for using an interactive media guidance application implemented on mobile user equipment to retrieve program listings information based on a user's current location in accordance with one embodiment of the present invention.

At step 1634, the interactive media guidance application may determine the user's current location using any suitable approach, such as, for example, the approaches described in connection with FIGS. 4b and 4c.

At step 1636, the interactive media guidance application may determine if media information for the user's current location has already been retrieved. For example, the user may have retrieved media information for a plurality of geographic regions from the media database. In another example, the user may have previously visited the current location and may have retrieved media information for the current location during the previous visit. The interactive media guidance application may search locally-stored media information to determine if any of the media information is specific to the user's current location.

If the media information for the user's current location has already been retrieved, then at step 1642, the interactive media guidance application displays the media information for the user's current location.

If the media information for the user's current location has not yet been retrieved, then at step 1638, the interactive media guidance application transmits information regarding the user's current information to the media database. The interactive media guidance application may be required to convert the information regarding the user's current location into a format accepted by the media database, as described in connection with FIG. 16a. In some embodiments, the network processor may be configured to access media information based on location from the media database. In this approach, the network processor is not required to communicate the user's location to the media database.

If more than one service provider is available for the user's current location, the user may select a service provider for which to retrieve media information (as discussed in step 1614 (FIG. 16a)). Alternatively, the interactive media guidance application may automatically select a service provider if the user previously selected a service provider for the user's current location (as discussed in step 1612 (FIG. 16a)).

At step 1640, the interactive media guidance application retrieves media information for the user's current location from the media database.

At step 1642, the interactive media guidance application displays the media information for the user's current location. For example, the interactive media guidance application may display the media information in a program listings display screen (e.g., screen 320 (FIG. 3c)).

FIG. 16e is an illustrative flow diagram 1650 for using an interactive media guidance application implemented on mobile user equipment to update program reminders based on a user's location in accordance with one embodiment of the present invention.

At step 1652, the interactive media guidance application allows the user to set a reminder for a television program at a first location. For example, the user may set a reminder for “Survivor” while the user is at LaGuardia Airport.

At step 1654, in response to the user moving to a second location (e.g., Boston, Mass.), the interactive media guidance application retrieves program listings information for the second location. The interactive media guidance application may retrieve program listings information for the second location in accordance with the approach discussed in FIG. 16a.

At step 1656, the interactive media guidance application searches the retrieved program listings information for the second location for the television program. For example, the interactive media guidance application may search the retrieved program listings for an entry for “Survivor”.

At step 1658, the interactive media guidance application updates the reminder, to refer to the channel on which the television program is being broadcast in the second location. For example, the interactive media guidance application may update the reminder for “Survivor” to indicate that it will be broadcast on Channel 2 in Boston.

FIG. 16f is an illustrative flow diagram 1660 for using an interactive media guidance application implemented on mobile user equipment to update favorite channels based on a user's location in accordance with one embodiment of the present invention.

At step 1662, the interactive media guidance application allows the user to set a favorite channel at a first location. For example, the user may set WNBC 4 as a favorite channel while the user is at LaGuardia Airport.

At step 1664, in response to the user moving to a second location (e.g., Boston, Mass.), the interactive media guidance application retrieves program listings information for the second location. The interactive media guidance application may retrieve program listings information for the second location in accordance with the approach discussed in FIG. 16a.

At step 1666, the interactive media guidance application searches the program listings information to determine the channel in the second location that corresponds to the favorite channel in the first location. For example, the interactive media guidance application may compare the program listings information for the favorite channel with program listings information for channels at the second location to determine if any of the channels correspond to the favorite channel. The interactive media guidance application may determine that the local NBC affiliate in Boston is WHDH 7.

At step 1668, the interactive media guidance application updates the favorite channel to refer to the corresponding channel in the second location. For example, the interactive media guidance application may update the favorite channel for WNBC 4 to WHDH 7.

One skilled in the art will appreciate that the invention can be practiced by other than the prescribed embodiments, which are presented for purposes of illustration and not of limitation, and the invention is limited only by the claims which follow.

1. A method for providing audible reminders that identify the videos for which the audible reminders are provided, comprising:
receiving a user input identifying a video;
setting a reminder for the identified video;
retrieving from a database of audio signals an audio signal for the identified video, wherein the audio signal is associated with the identified video and identifies its associated video when heard by the user; and
at a predetermined time or times, sounding without user input an audible reminder for the user from the retrieved audio signal such that the audible reminder, when heard by the user, identifies the video to the user.

2. The method of claim 1, wherein sounding the audible reminder comprises sounding the audible reminder with a mobile device.

3. The method of claim 2, wherein:
the mobile device is a mobile phone; and
the method further comprises at the predetermined time or times, setting without user input the audio signal as a default ringtone of the mobile phone such that when a call is subsequently received, the ringtone is sounded for the user as the audible reminder.

4. The method defined in claim 2 further comprising transmitting the audio signal to the mobile device as a Multimedia Messaging Service (MMS) message.

5. The method of claim 1, wherein:
the video is a television program that is an episode of a series;
setting the reminder comprises setting a reminder for each episode of the series;
the audio signal is associated with each episode of the series; and
sounding the audible reminder from the retrieved audio signal comprises sounding the audible reminder for each episode of the series at a predetermined time appropriate to each episode.

6. The method of claim 1, wherein:
the user input comprises a keyword or genre identifying a plurality of videos;
setting a reminder comprises setting a reminder for each of the identified videos;
retrieving an audio signal for the identified video comprises retrieving an audio signal for each of the identified videos from the database of audio signals; and
sounding the audible reminder comprises sounding an audible reminder for each identified video from each video's associated audio signal at a predetermined time appropriate for each video.

7. The method of claim 1, wherein:
receiving the user input comprises receiving the user input from a remote user device with a web server; and
sounding the audible reminder comprises transmitting the audio signal to a mobile device and sounding the audible reminder with the mobile device.

8. The method of claim 1, wherein:
receiving the user input comprises receiving the user input from a remote control; and
sounding the audible reminder comprises transmitting the audio signal to a mobile device and sounding the audible reminder with the mobile device.

9. The method of claim 1, wherein the audio signal is a theme song corresponding to the identified video.

10. A method for providing audible reminders that identify an associated video to a user of a mobile device, comprising:
detecting a triggering event for providing an audible reminder for a video; and
in response to the triggering event, sounding without user input an audible reminder that, when heard by the user, identifies the video to the user.

11. The method defined in claim 10 wherein:
the method further comprises receiving an audio signal for the audible reminder; and
sounding the audible reminder comprises generating the audible reminder from the received audio signal.

12. The method defined in claim 10 wherein detecting the triggering event comprises:
comparing the current time to entries in a locally-stored reminder schedule; and
determining a triggering event exists when an entry in the reminder schedule matches the current time.

13. The method defined in claim 10 wherein:
detecting the triggering event comprises detecting a Multimedia Messaging Service (MMS) message; and
sounding the audible reminder comprises generating the audible reminder from an audio signal contained in the MMS message.

14. The method defined in claim 10 wherein:
detecting the triggering event comprises detecting a Multimedia Messaging Service (MMS) message; and
sounding the audible reminder comprises generating the audible reminder from a locally-stored audio signal associated with indicating the receipt of an MMS message.

15. The method defined in claim 10 wherein sounding the audible reminder comprises:
retrieving from a database of audio signals an audio signal for the video, wherein each audio signal in the database is associated with a video and identifies its associated video when heard by the user; and
generating the audible reminder from the retrieved signal.

16. The method defined in claim 10 wherein the audible reminder is a theme song corresponding to the video.

17. The method defined in claim 10 wherein the mobile device is a mobile phone.

18. The method defined in claim 10 wherein the video is a television program.

19. The method defined in claim 10 further comprising displaying the video for the user.

20-57. (canceled)
